(19) United States
(12) Patent Application Publication
(10) Pub. No.: US 2020/0148448 A1
(43) Pub. Date: May 14, 2020

(54) Apparatus and Process for Packaging Materials

(71) Applicant: Curation Foods, Inc., Santa Maria, CA (US)

(72) Inventors: Steven Bitler, Menlo Park, CA (US); Angel Reyes, Santa Maria, CA (US); Shehbaz Singh, Santa Maria, CA (US); John Liebenthal, Avon, IN (US); Carlos Rodriguez, Santa Maria, CA (US); Bernard Susai, Pismo Beach, CA (US)

(73) Assignee: Curation Foods, Inc., Santa Maria, CA (US)

(21) Appl. No.: 16/513,673

(22) Filed: Jul. 16, 2019

Related U.S. Application Data
(63) Continuation-in-part of application No. 15/604,629, filed on May 24, 2017.
(60) Provisional application No. 62/698,908, filed on Jul. 16, 2018.
(60) Provisional application No. 62/340,966, filed on May 24, 2016.

(51) Int. Cl. B65D 81/20; B65D 71/00; B65D 85/34; B65B 25/04; B65B 51/10; A23B 7/148; A23B 7/152

(52) U.S. Cl. CPC B65D 81/2084; B65D 71/0096; B65D 85/34; A23V 2002/00; B65B 51/10; A23B 7/148; A23B 7/152; B65B 25/041

(57) ABSTRACT

A system for automatically sealing a plastic bag/enclosure over containers of biological materials carried on a pallet, comprising: a sealing system for automatically sealing a pallet bag enclosing a plurality of containers of biological materials wherein said pallet bag encloses the containers and an atmosphere surrounding the containers, the pallet bag optionally comprising at least one ACM and optionally including a reinforced portion. The pallet bag generally surrounds a number of flats or boxes on pallets containing fruits or vegetables that are sealed with or without a membrane to create an optimally suited atmosphere to control ripening, extend shelf-life, minimize microbial growth, maintain color, and maintain freshness.

### CROSS-REFERENCE TO RELATED APPLICATIONS

This application claims priority of U.S. Provisional Application No. 62/698,908, filed Jul. 16, 2018 and is a continuation-in-part of U.S. application Ser. No. 15/604,629, filed May 24, 2017, U.S. Provisional Application No. 62/340,966, filed May 24, 2016, and relates to the following commonly assigned applications, application Ser. No. 13/368,216, filed Feb. 7, 2012, application Ser. No. 13/368,216, filed Feb. 7, 2012 which is a continuation of Ser. No. 09/858,190, filed May 15, 2001, now U.S. Pat. No. 8,110,232. Ser. No. 09/858,190 is also related to claims priority under 37 CFR 1.78(a)(5) from Provisional Application Ser. No. 60/325,762, filed May 26, 2000, which resulted from the conversion of application Ser. No. 09/580,379, into a provisional application under 37 CFR 1.53(c)(2). This application is also related to (1) application Ser. No. 09/989,682, filed Nov. 20, 2001, now U.S. Pat. No. 7,601,374, which is a continuation-in-part of Ser. No. 09/858,190, and (2) application Ser. No. 12/553,852 filed Sep. 3, 2009, now U.S. Pat. No. 8,092,848, which is a divisional of Ser. No. 09/989,682. The entire disclosures of each of those patents and applications are incorporated herein by reference for all purposes.

### BACKGROUND OF THE INVENTION

This invention relates to the packaging of respiring and non-respiring biological materials, particularly various berries. This invention is useful in packaging any and all fresh fruit and vegetables. In particular, it is useful in increasing the speed of the packing operation, reduces worker fatigue, increases reproducibility, decreases errors, and allows for automation of the packaging process for a variety of pallet sized packaging of biological materials.

Respiring and non-respiring biological materials, e.g. fruits and vegetables, consume oxygen (O₂) and produce carbon dioxide (CO₂) at rates which depend upon the stage of their development, the atmosphere surrounding them and the temperature. In modified atmosphere packaging (MAP), the objective is to produce a desired atmosphere around respiring and non-respiring materials by placing them in a sealed container whose permeability to O₂ and CO₂ is correlated with (i) the partial pressures of O₂ and CO₂ in the air outside the package, and (ii) the temperature, to produce a desired atmosphere within the container and (iii) the gas permeation properties of the chosen package materials and components. In many cases, the container includes an atmosphere control member having a high permeability to O₂ and CO₂. In controlled atmosphere packaging (CAP), the objective is to produce a desired atmosphere around respiring and non-respiring materials by displacing some or all of the air within a container by one or more gases, e.g. nitrogen, O₂, CO₂ and ethylene, in desired proportions. Reference may be made, for example, to U.S. Pat. No. 3,360,380 (Bedrosian), U.S. Pat. No. 3,450,542 (Badran), U.S. Pat. No. 3,450,544 (Badran et al.), U.S. Pat. No. 3,798,333 (Cummin et al), U.S. Pat. No. 3,924,010 (Erb), U.S. Pat. No. 4,003,728 (Rath), U.S. Pat. No. 4,734,324 (Hill), U.S. Pat. No. 4,779,524 (Wade), U.S. Pat. No. 4,830,863 (Jones), U.S. Pat. No. 4,842,875 (Anderson), U.S. Pat. No. 4,879,078 (Antoon), U.S. Pat. No. 4,910,032 (Antoon), U.S. Pat. No. 4,923,703 (Antoon), U.S. Pat. No. 4,987,745 (Harris), U.S. Pat. No. 5,041,290 (Wallace et al.) U.S. Pat. No. 5,045,331 (Antoon), U.S. Pat. No. 5,063,753 (Woodruff), U.S. Pat. No. 5,160,768 (Antoon), U.S. Pat. No. 5,254,354 (Stewart), U.S. Pat. No. 5,333,394 (Herdeman), U.S. Pat. No. 5,433,335 (Raudalus et al.), U.S. Pat. No. 5,460,841 (Herdeman), U.S. Pat. No. 5,556,658 (Raudalus et al.), U.S. Pat. No. 5,658,607 (Herdeman), U.S. Pat. No. 6,013,293 (De Moor) and U.S. Pat. No. 6,376,032 (Clarke et al), International Publication Nos. WO 94/12040 (Fresh Western) and WO 00/04787 (Landec), and European Patent Applications Nos. 0,351,115 and 0,351,116 (Courtaulds). The disclosure of each of these patents and publications is incorporated herein by reference in its entirety.

The preferred packaging atmosphere for fresh respiring and non-respiring fruit or vegetables often depends on the age of the fruit or vegetables and the changes (if any) which are desired. Generally, for example, the preferred O₂ content during storage of unripe fruits is lower than the preferred O₂ content during subsequent ripening at a higher temperature. This fact causes problems for both MAP and CAP. For example, in MAP, although the O₂ permeability of the container generally increases with temperature (especially if it contains an atmosphere control member comprising a crystalline polymer having an appropriate melting point, as disclosed in U.S. Pat. No. 6,376,032 and International Publication No. WO 00/04787), the increase is often insufficient to avoid the need for significant compromise between the preferred atmospheres at different stages. In CAP, it is theoretically possible to monitor the packaging atmosphere and to change it as often as is necessary to maintain the preferred level of O₂ (and other gases). But this is difficult and expensive, and often impractical.

For example, U.S. Pat. No. 5,799,495 discloses a system in which biologically respiring and non-respiring material, e.g. fruit, is transported and ripened in a sealed container, and is first surrounded by a first atmosphere and thereafter by a second atmosphere, the second atmosphere containing more oxygen than the first. The atmospheres are controlled by injection of appropriate gases directly into the container.

For the transportation of berries, for example, it is typically desirable to use pallet packaging to generate a controlled or modified atmosphere inside the pallet to extend shelf-life of produce, minimize microbial growth, maintain color, and maintain freshness.

Currently, Strawberries are hand-picked in the field, placed into plastic clam shell enclosures that are then placed into cardboard trays and cardboard trays are stacked onto a wooden pallet to a height of about 100-120 inches containing about 1000 lbs. of berries. The pallet of packaged berries is transported to a cooler and the temperature reduced to about 32° F. The cooled pallet is then placed by forklift onto a structurally robust metal support and transfer mechanism at which time jaws or clamps encircle the cardboard trays of berries, lifts up the trays as one unit and workers put a combination of cardboard and plastic sheeting onto the pallet and then the trays of berries are lowered back onto the pallet. Workers then staple or tack the about 6 inch flap of plastic sheet that extends beyond the pallet edges to the trays of berries. A pallet bag is lowered onto the pallet from above to overlap with the tacked up sheet. Tape (about 6 inch wide) is then used to seal the pallet bag to the sheet while the, for example, 1000 lb. pallet spins on the support system. A slit or hole is made in the side of the pallet bag and a probe inserted that can remove some of the inside air and replace with carbon dioxide to a target concentration. See, U.S. Pat. No. 7,770,366, which is incorporated herein by reference in its entirety.

However, there are several problems with the prior system, including:
(a) The plastic sheet between the pallet and berry trays cannot be applied in the field because the plastic sheet is often damaged during transport leading to leaks in the bag;
(b) The prior system is slow and subject to human error since it requires so many manual steps to apply the current bag system;
(c) The prior system requires a large footprint within the cooler since the overall system must be structurally strong enough to hold, move, raise, rotate and manipulate a 1000 lb. pallet with structural strength to spare while providing a safe work environment to works manually applying the packaging to the pallet;
(d) The prior system has a high failure rate, as defined by pallet bags not maintaining the target atmosphere due to manual error resulting in rips, tears, leaks at the seal where the bag and bottom sheet meet and are taped, etc. In particular the taped seal is a source of significant leak failure;
(e) The prior system, equipment, and slow manual process time lead to a slow system;
(f) The prior system is prone to worker health issues due to workers bending over, stapling sheet, lifting, and other labor-intensive involvement; and
(g) In addition, without the use of the BreatheWay® membrane, the current system can develop high CO₂ levels that lead to off-odor, off-taste and a short shelf-life.

Some of these problems are addressed using a single-bag system with the use of a designed gas permeable membrane or atmosphere control member (ACM), such as the BreatheWay® membrane described in patents cited and incorporated herein by reference in their entirety and by automating the system such as in U.S. application Ser. No. 15/604,629 and the co-filed U.S. Provisional applications titled “Pallet Bag” and “Automated Process and Apparatus for Packaging Biological Materials,” which are incorporated herein by reference in their entirety.

However, in an embodiment of that system the load of biological materials (e.g., berries), is placed on a pallet wherein the pallet must be prepared with a pallet load bag that can be lifted around the load and sealed to establish the packaging environment for the materials. From the prior art methods of packaging other pallet loads of such materials, the typical approach is to manually gather the bag to place around the pallet for subsequent raising and sealing around the load of materials. This manual process is time-consuming, subject to non-repeatability errors, and prevents an automated overall packaging approach.

The embodiments of the present invention address this problem by adding critical automation to improve the speed and quality of the process, addressing the aforementioned problems.

### BRIEF SUMMARY

The first area of the invention includes the following Aspects.

A first aspect of the invention includes a sealed pallet packaging system which comprises
(a) at least 100 lbs of respiring and non-respiring biological material in a plurality of containers,
(b) a pallet tray,
(c) a packaging atmosphere around the respiring and non-respiring biological material, and
(d) a packaging film enclosing the respiring and non-respiring biological material and the packaging atmosphere which
(i) provides a pathway for oxygen and carbon dioxide to enter or leave the packaging atmosphere, and
(ii) consists of a membrane which comprises a microporous film and a polymeric coating on the microporous film,
   wherein the packaging film is attached to the pallet tray using a mechanical seal extending into a portion of the pallet tray.

The sealed pallet packaging system according to the first aspect may use a packaging film that is connected to the pallet tray wherein the packaging film encloses the respiring and non-respiring biological material and the packaging atmosphere in a sealed environment.

The sealed pallet packaging system may be used with respiring and non-respiring biological material is a fruit which ripens through a climacteric and in some embodiments the respiring and non-respiring biological material has not passed its climacteric, in another embodiment the respiring and non-respiring biological material has passed its climacteric.

The respiring and non-respiring biological material can be climactic or non-climactic fruits selected from the group consisting of apples, apricots, avocados, bananas, blueberries, cherimoyas, dates, figs, kiwis, mangos, melons, peaches, papayas, pears, peppers, persimmons, plums, cherries, grapes, lemons, oranges, tomatoes, raspberries, blackberries, and strawberries. The respiring and non-respiring biological material can also be vegetables selected from the group consisting of potatoes, onions, carrots, peppers, broccoli, celery, cucumbers, lettuce, corn, garlic, sweet potatoes, cauliflower, spinach, green beans, cabbage, kale, green onions, and asparagus.

The packaging atmosphere is customized according to the respiring and non-respiring biological material in the sealed pallet system. In one example, the packaging atmosphere contains 1.5 to 6% of oxygen and less than 15% of carbon dioxide, with the total quantity of oxygen and carbon dioxide being less than 16%, and the atmosphere control member has an R ratio at 13° C. of at least 2.

In some preferred embodiments the packaging film is connected to the pallet tray using a retention cord. The packaging film may alternatively be adhered using a fluid or adhesive as disclosed herein. The film may use both a mechanical seal and a chemical seal.

The sealed pallet packaging system may have a packaging atmosphere contains exogenous ethylene.

Another aspect of the invention includes a method of preserving respiring and non-respiring biological materials, the method comprising providing a sealed pallet packaging system which comprises
(i) at least 100 lbs. of the respiring and non-respiring biological materials;
(ii) a pallet tray;
(iii) a packaging atmosphere around the biological materials
(iv) a plastic packaging film containing the biological materials and packaging atmosphere; and
(v) an atmosphere control member which
(i) provides a pathway for oxygen and carbon dioxide; and
(ii) comprises (a) a membrane which comprises a microporous film and a polymeric coating on the microporous film and/or (b) any other rival control system such as the microperforations referenced herein, for example, in paragraph 0054.

wherein the packaging film is connected to the pallet tray using a retention cord forming a sealed environment containing the respiring and non-respiring biological material and the packaging atmosphere.

The method can be used with fruits selected from the group consisting of apples, apricots, avocados, bananas, blueberries, cherimoyas, dates, figs, kiwis, mangos, melons, peaches, papayas, pears, peppers, persimmons, plums, cherries, grapes, lemons, oranges, tomatoes, raspberries, blackberries, and strawberries. The method can also be sued with vegetables selected from the group consisting of potatoes, onions, carrots, peppers, broccoli, celery, cucumbers, lettuce, corn, garlic, sweet potatoes, cauliflower, spinach, green beans, cabbage, kale, green onions, and asparagus. The method may automatically seal the packaging film mechanically using a retention cord and chemically using a liquid sealant such as glue, hot-melt adhesive, epoxy, silicone, and caulk.

Another aspect of the invention is a system for automatically sealing a plastic bag/enclosure over containers of respiring and non-respiring biological materials carried on a pallet having a pallet tray beneath the containers, comprising: a sealing system for automatically sealing a pallet bag to the pallet tray by inserting a retention cord into a receptacle portion of the pallet tray; a system for automatically stretching a plastic bag/enclosure over containers containing at least 100 lbs. of respiring and non-respiring biological material; and an atmosphere control member which provides a pathway for oxygen and carbon dioxide and consists of a membrane which comprises a microporous film and a polymeric coating on the microporous film.

Another aspect of the invention is a system for automatically sealing a plastic bag/enclosure over containers of respiring and non-respiring biological materials carried on a pallet having a pallet tray beneath the containers, comprising: a mechanical seal system for automatically sealing a pallet bag to the pallet tray by inserting a retention cord into a receptacle portion of the pallet tray; a system for automatically stretching a plastic bag/enclosure over containers containing at least 100 lbs. of respiring and non-respiring biological material; and a gas delivery system for automatically piercing said bag/enclosure and for delivering a gaseous modified atmosphere inside said bag/enclosure. The gas delivery system includes one or more needles/nozzles linked to said bagging system. The systems of the aforementioned aspects may automatically applies a liquid seal to the receptacle portion of the pallet tray.

The aspects of the invention may also include an injector system for forming one or more calibrated holes in the side of the bag/enclosure after said bag/enclosure is sealed around said containers of perishables, to form and to maintain a desired modified atmosphere inside said bag/enclosure, wherein the number and size of holes is based, in part, on the weight and nature of said perishables.

In an aspect of the invention the pallet tray is applied to the pallet in the field where the respiring and non-respiring biological materials are grown such that the containers of fruits and vegetables can be stacked on the pallet tray, which optionally may be affixed mechanically or chemically to the pallet prior to bringing the pallet tray to the harvesting field/location.

Another aspect of the invention is a system for automatically sealing a plastic bag/enclosure over containers of respiring and non-respiring biological materials carried on a pallet having a pallet tray beneath the containers, comprising: a lip along the outside portion of the pallet tray; a mechanical seal system for automatically sealing stretch film to the pallet tray by stretching the film over the pallet tray lip wherein the system automatically stretches a plastic bag/enclosure over containers containing at least 100 lbs. of respiring and non-respiring biological material; and a gas delivery system for automatically piercing said bag/enclosure and for delivering a gaseous modified atmosphere inside said bag/enclosure.

### BRIEF DESCRIPTION OF THE DRAWINGS

The drawings are for illustrative purposes and do not depict every embodiment of the invention.

FIG. 1 is a depiction of a front view of the packaging apparatus.

FIG. 2 is a depiction of a rear view of the packaging apparatus.

FIG. 3 is a depiction of a top down view of the packaging apparatus.

FIG. 4 is a depiction of a side view of packaged product from the packaging apparatus.

FIG. 5a-b depict the rotating spatula in different positions

FIG. 5c depicts the squeeze members and apparatus.

FIG. 6a depicts the pallet receiver.

FIG. 6b shows the pallet receiver with a gathered pallet bag.

FIGS. 7a-7d depict views of the seal bar, gas injection and vacuum.

### DESCRIPTION OF THE DRAWINGS

In the Summary of the Invention above and in the Detailed Description of the Invention, the Examples, and the Claims below, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

In describing and claiming the invention below, the following abbreviations, definitions, and methods of measurement (in addition to those already given) are used. OTR is O₂ permeability. COTR is CO₂ permeability. EtTR is ethylene transmission rate. ERATR is ERA transmission rate. OTR, COTR, EtTR and ERATR values are given in ml/m²·atm·24 hrs; in some cases, the equivalent in cc/100 inch²·atm·24 hrs is given in parentheses. OTR and COTR values referred to herein can be measured using a permeability cell (supplied by Millipore) in which a mixture of O₂, CO₂ and helium is applied to the sample, using a pressure of 0.7 kg/cm² (10 psi) except where otherwise noted, and the gases passing through the sample were analyzed for O₂ and CO₂ by a gas chromatograph. The abbreviation P₁₀ is used to mean the ratio of the oxygen permeability at a first temperature T₁° C. to the oxygen permeability at a second temperature T₂, where T₂ is (T₁−10°) C. T₁ being 10° C. and T₂ being 0° C. unless otherwise noted. The abbreviation R or R ratio is used to mean the ratio of CO₂ permeability to O₂ permeability, both permeabilities being measured at 20° C. unless otherwise noted. Pore sizes given in this specification are measured by mercury porosimetry or an equivalent procedure. Parts and percentages are by weight, except for percentages of gases, which are by volume; temperatures are in degrees Centigrade, and molecular weights are weight average molecular weights expressed in Daltons. For crystalline polymers, the abbreviation Tₒ is used to mean the onset of melting, the abbreviation Tₚ is used to mean the crystalline melting point, and the abbreviation ΔH is used to mean the heat of fusion. Tₒ, Tₚ and ΔH are measured by means of a differential scanning calorimeter (DSC) at a rate of 10° C./minute and on the second heating cycle. Tₒ and Tₚ are measured in the conventional way well known to those skilled in the art. Thus Tₚ is the temperature at the peak of the DSC curve, and Tₒ is the temperature at the intersection of the baseline of the DSC peak and the onset line, the onset line being defined as the tangent to the steepest part of the DSC curve below Tₚ.

The term “comprises” and grammatical equivalents thereof are used herein to mean that other components, ingredients, steps etc. are optionally present. For example, an article “comprising” (or “which comprises”) components A, B and C can consist of (i.e. contain only) components A, B and C, or can contain not only components A, B and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “controlled atmosphere” is used herein to include an atmosphere produced by adding further gases to an existing atmosphere (including the addition of additional quantities of gas already present in the existing atmosphere), the further gases being added directly to the atmosphere (not passing through a permeable body) before reaching the atmosphere.

The term “closed container” is used herein to include a large container, for example a conventional shipping or trucking container which can be loaded onto a ship or a truck, and which is sealed sufficiently to permit a controlled atmosphere to be maintained therein by conventional means well-known to those skilled in the art. The term “shipping or trucking container” is used herein to mean a container which has a volume of at least 8 m³ and which can be loaded onto a ship or a truck. Such containers are well known to those skilled in the art of storing and transporting fruits and vegetables, and are available in a range of standard sizes.

The term “source of exogenous ERA” is used herein to mean a material, object or system which, either immediately or when activated, generates ethylenic ripening agent. The term “latent source of exogenous ERA” is used herein to mean a material, object or system which is generating little or no ERA, but which can be activated so that it generates substantial quantities of exogenous ERA. The term “residue of a source of exogenous ERA” is used herein to mean a material, object or system which is not a part of a fruit and which remains after exogenous ERA has been generated from a source of exogenous ERA. The residue may be for example (i) a solid material which served as a support for exogenous ERA itself or for one or more precursors of exogenous ERA, or (ii) a liquid residue remaining after a solution of a precursor for an ERA, e.g. 2-chloroethyl phosphonic acid, has been used to generate exogenous ethylene and/or a solid residue resulting from the evaporation of solvent from such a solution. The term “residue of exogenous ERA” is used herein to denote a chemical compound which results from the reaction of exogenous ERA with the fruit being ripened (in which case it is optionally part of the ripe fruit) or with another substance within the sealed package.

The term “ripening” is used herein to mean increasing ripeness; it includes, but is not limited to and generally does not mean, ripening to a point which results in a product which in a retail store would be sold as “ripe”. When applied to fruits which ripen through a climacteric, the term “ripening” means ripening the fruits at least through the climacteric. The term “unripe fruits” is used herein to mean fruits which require ripening before they can be sold in retail stores. When applied to fruits which ripen through a climacteric, the term “unripe fruits” means fruits which have not reached their climacteric. The term “banana” is used herein to include plantains.

“Preferably” or “Preferable” means preferred but not required.

Where reference is made herein to sealed packages and sealed containers, and to sealing bags and other containers containing biological materials, it is to be understood that the sealing can be, but generally is not, hermetic sealing. Conventional methods for sealing bags and other containers can conveniently be used in this invention. Such conventional methods include, for example, the use of a cable tie to seal the neck of a polymeric bag. A seal made by conventional methods often is not a hermetic seal, and has the advantage that it permits equilibration of the pressures inside and outside the bag. If the container is sealed hermetically, it will generally be desirable to include one or more pinholes in the container, to achieve such equilibration. The less complete the sealing of the container, the less the influence of the permeability of the container on the packaging atmosphere within it. Thus, even a poor seal may be sufficient, or even desirable, for example when the desired O₂ content of the packaging atmosphere lies between the O₂ content of the atmosphere surrounding the package and the O₂ content of the packaging atmosphere that would result if the seal was a hermetic seal. Under such circumstances, the sealing could be designed to permit a controlled amount of direct exchange between the packaging atmosphere and the atmosphere surrounding the container.

A pallet packaging system is disclosed herein that addresses many of the above mentioned problems with the current pallet packaging approach described in the Background Section.

### Pallet Bag—Generating Internal Atmospheres

The Pallet bag may be a standard thickness, for example about 2 to about 8 mil, more preferably about 3 to about 4 mil and may be composed of any plastic material, low density polyethylene (LDPE) is a preferred plastic (since by using a mechanical locking device no heat sealing is needed—but heat sealing may be applied) but any plastic monolayer, plastic laminates or multicomponent laminates may be used for example, PE, PP, PET, thermoplastic elastomer, stretch plastic, Nylon, paper/plastic laminates, and the like. Other bag thicknesses and flexible materials may be used, though the material need be sufficiently flexible to be used with the mechanical seal provided in the pallet packaging system herein. Suitable flexible material for the bag may be PE, PP, Nylon, polyester, recycled or repurposed plastic, low cost paper/plastic laminates, and other laminates. Preferred materials include LDPE, Linear low density polyethylene (LLDPE), ultra-low density polyethylene (ULDPE). Depending on the method of applying the bag over the pallet, a stretch plastic may be preferred.

Because heat sealing may be unnecessary when using a “mechanical seal”, the pallet bag material may be selected based on cost or moisture vapor transmission rate (MVTR) properties or puncture resistance or other reasons. Integral to the pallet packaging system is the use of atmosphere control technology, for example a BREATHEWAY® membrane or microperforations as appropriate. Preferably the pallet packaging system uses a BREATHEWAY® membrane, as described in other Apio/Landec patents and patent applications, including U.S. Pat. Nos. 5,254,354; 6,376,032; 6,548,132, and 7,329,452, each of which is incorporated by reference in its entirety. Use of the membrane technology allows effective atmosphere control of oxygen and carbon dioxide for extension of shelf-life, taste, freshness, and other benefits, such as appearance.

The pallet bag/cover may optionally have a ‘valve” mechanism built into the bag that may be a one-way or two-way valve to assist in the speed and efficiency of removing the air in the bag and replacing with CO₂ which may eliminate the need to cut and then retape the bag after CO₂ injection.

The pallet bag may optionally be a custom designed bag which, when opened and placed over the pallet will have a flat top to lie smoothly over the top layer of product trays. This bag design will not leave any hanging ears, which otherwise require taping and add extra labor, cost and time. A preferred pallet bag may be designed to fit a unit load of 48″×40″ (Standard Grocery Manufacturers Association (GMA) pallet) with varying heights and will come in a roll form. Alternatively, the pallet bag may be designed for use with a sea pallet, which commonly has a size of 1200 mm×1000 mm. Alternatively, the pallet bag may be sized for a European pallet of 800 mm×1200 mm used in some parts of Europe.

These bags in a roll will allow for easy automation. Such pallet bags will be proprietary and an essential element of the entire system to drive efficiency, lower costs, and to render a clean looking finished pallet with the right atmosphere. In one embodiment, a fully automated system is used from using film in the shape of a long tube that can be automatically cut to size for a custom pallet height, with the top heat sealed and holes cut over which may be placed ACM membranes, such as BreatheWay® membranes, or microperforations for atmosphere control.

The aspects of the pallet bag and packaging apparatus can result in a greater production rate, a lower rate of failure, reduced labor costs, reduced machine shut-down time, a more reliable and consistent atmosphere surrounding the fruits and vegetables, and a more optimized treatment of the contained fruits and vegetables during shipment and storage.

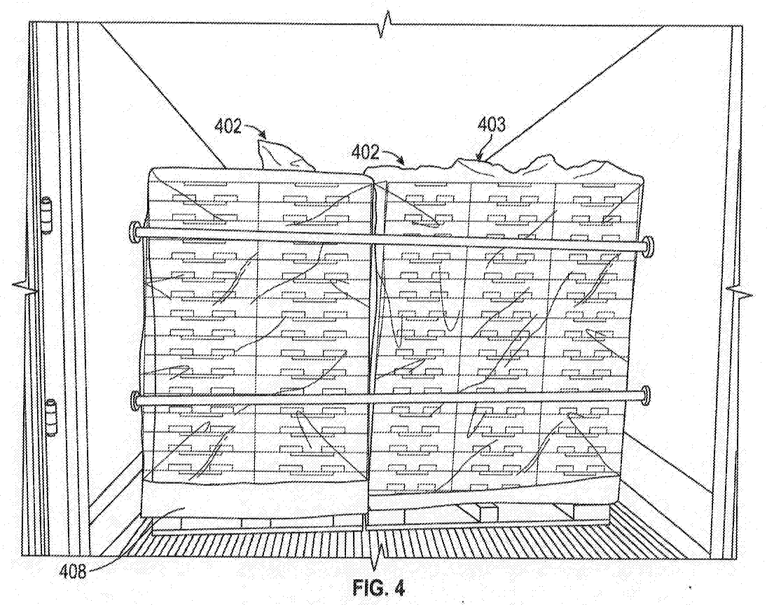

The pallet bags are designed to hold about 50 to about 200 containers of product, depending on the size of the containers, as depicted in FIG. 4. The pallet bags can be used with common retail containers for wholesale packaging that are preferably stackable, such as flats, boxes or cartons. It is preferred for the containers to be palletized where the containers are stacked on pallets to reduce the handling of individual containers.

In a preferred embodiment, the membrane is on top of the pallet to prevent the membrane from being blocked by walls or other pallets during shipping. In some embodiments, a reinforced pallet bag is used over the load of product (e.g., berries) where the bottom portion is reinforced as described in U.S. Provisional Application No. 62/701,364. For example, the bottom portion (e.g., about 4 inches to about 8 inches, preferably about 6 inches) is reinforced with polypropylene or a similar puncture resistant material to help resist bag damage in the form of holes or rips that impact the ability of the bag or bag and membranes from delivering the target atmospheres (e.g., O₂ and CO₂).

The bag may be anywhere from about 50 to about 150 inches in length, preferably about 113 to 120 inches. The circumference of the bag is about 150 to about 200 inches, preferably about 180 to about 190 inches. The bag is preferably a toughened version of LDPE but could be other plastics. The bag is preferably gusseted with the sides folded inward and has at least one but preferably two holes about 18 inches from top. In a preferred embodiment membranes are placed over the at least one holes.

### Control Members

The containers used in the present invention preferably, but not necessarily, include at least one atmosphere control member which provides a pathway for O₂ and CO₂, and which preferably comprises a gas-permeable membrane comprising

(1) a microporous polymeric film, and

(2) a polymeric coating on the microporous film.

The atmosphere control member is preferably a control member as described in one or more of U.S. Pat. Nos. 6,013,293 and 6,376,032 and International Publication No. WO 00/04787, each of which is incorporated by reference herein in its entirety. The atmosphere control member or members generally provide at least 50%, preferably at least 75%, of the O₂ permeability of the sealed container.

The microporous polymeric film preferably comprises a network of interconnected pores having an average pore size of less than 240 micron, preferably with at least about 70% of the pores having a pore size of less than about 240 micron and, preferably, at least about 80% of the pores having a pore size less than about 150 micron. Preferably the pores in the microporous film constitute about 35 to about 80% by volume of the microporous film.

The polymeric coating on the control member can optionally comprise a crystalline polymer having a peak melting temperature Tₚ of about −5 to about 40° C., for example about 0 to about 15° C. or about 10 to about 20° C., an onset of melting temperature Tₒ such that (Tₚ−Tₒ) is less than about 10° C., and a heat of fusion of at least about 5 J/g. The polymer can be a side chain crystalline polymer moiety comprising, and optionally consisting of, units derived from (i) at least one n-alkyl acrylate or methacrylate (or equivalent monomer, or example an amide) in which the n-alkyl group contains at least 12 carbon atoms, for example in amount about 35-100%, preferably about 50-100%, often about 80-100%, and optionally (ii) one or more comonomers selected from acrylic acid, methacrylic acid, and esters of acrylic or methacrylic acid in which the esterifying group contains less than 10 carbon atoms.

The preferred number of carbon atoms in the alkyl group of the units derived from (i) depends upon the desired melting point of the polymer. For the packaging of biological materials, it is often preferred to use a polymer having a relatively low melting point, for example a polymer in which the alkyl groups in the units derived from (i) contain 12 and/or 14 carbon atoms. The polymer can be a block copolymer in which one of blocks is a crystalline polymer as defined and the other block(s) is crystalline or amorphous.

Preferred block copolymers comprise (i) polysiloxane polymeric blocks, and (ii) crystalline polymeric blocks having a Tₚ of about −5 to about 40° C. Other polymers which can be used to coat the microporous film include cis-polybutadiene, poly (4-methylpentene), polydimethyl siloxane, and ethylene-propylene rubber.

The gas-permeable membrane optionally has one or more of the following properties:
(i) a P₁₀ ratio, over at least one about 10° C. range between about −5 and about 15° C. or between about 10 and about 20° C. of at least about 2.0 to 2.8;
(ii) an OTR at all temperatures between about 20 and about 25° C. of about 2,480,000 to about 7,000,000 ml/m²·atm·24 hr. (160,000 to 450,000 cc/100 in²·atm·24 hr); and
(iii) an R ratio of at least about 1.3, preferably about at least 2.0, particularly at least about 3.0, especially at least about 3.5.

The O₂ permeability of the container at 13° C. per kilogram of fruits therein (OP13/kg) is preferably at least about 700, particularly at least about 1000, especially at least about 1500, ml/atm·24 hrs. The R ratio of the container at 13° C. is preferably at least about 1.3, more preferably at least about 2, particularly at least about 3. The ethylene permeability of the container at 13° C. per kilogram of fruits therein (EtP/13/kg) is preferably at least 3 times, particularly at least about 4 times, the OP13/kg of the container.

The permeability of the container, whether or not it includes an atmosphere control member, can be influenced by perforating the container in order to make a plurality of pinholes therein.

In this invention, the use of the BreatheWay® membrane in particular offers the ability to custom tune the level of oxygen and carbon dioxide in the pallet bag as well as compensate for changes in respiration rate from temperature change and time. The BreatheWay® membrane can be used as a “modulating and controlling” mechanism allowing the user to inject high level of carbon dioxide, for example 10%, 20% 30%, 40% or 50% carbon dioxide safely knowing that that BreatheWay® membrane will allow the carbon dioxide level to equilibrate in a target range within a reasonable time, for example if injected with about 20 to about 30% carbon dioxide the membrane allows the carbon dioxide level to equilibrate at 34° F. to about 15-18% within about 24 hours.

### Fruits

This invention is particularly useful for (but is not limited to) the ripening, storage and/or transportation of the wide range of fruits which ripen (or undergo other changes, for example, in the case of citrus fruits, de-greening) when exposed to ethylene or another ERA, for example apples, apricots, avocados, bananas, blueberries, cherimoyas, dates, figs, kiwis, mangos, melons, peaches, papayas, pears, peppers, persimmons, and plums (all of which go through a climacteric when they ripen), as well as cherries, grapes, lemons, oranges, tomatoes, raspberries, blackberries, and strawberries. Some aspects of the invention are especially useful for fruits which in commercial practice are ripened in ethylene-containing ripening rooms, for example avocados, bananas, Bartlett pears, kiwis, mangos, melons, peppers and tomatoes.

### Vegetables:

Any and all types of vegetables may be used in such a pallet packaging system. Vegetables may include for example potatoes, onions, carrots, peppers, broccoli, celery, cucumbers, lettuce, corn, garlic, sweet potatoes, cauliflower, spinach, green beans, cabbage, kale, green onions, asparagus, and the like.

### Storage of Unripe Fruits

When the invention is being used to store unripe fruits, it is possible to produce desired packaging atmospheres by the selection of containers which, when sealed around the quantities of fruits in question at the selected storage temperature, have appropriate permeabilities to O₂ and CO₂, and by the selection of an appropriate controlled atmosphere around the sealed packages. Those skilled in the art will have no difficulty, having regard to their own knowledge and the contents of this specification, in making appropriate selections to produce a desired packaging atmosphere or to make a desired compromise between (i) the cost and inconvenience of obtaining an entirely satisfactory combination of container and controlled atmosphere, and (ii) the disadvantage of storing the fruits in a packaging atmosphere which is in some ways unsatisfactory.

### Pallet Bagging Apparatus and Process

The pallet bagging apparatus and process may be fully automated, semi-automated, or manual in operation but preferably semi to fully automated and may increase the speed of bagging product to from about 40 pallets per hour to about 80 pallets per hour, preferably from about 50 to about 70 pallets per hour, more preferably from about 55 to about 65 pallets per hour with minimum defects, such as rips and tears. Ideally, the bagging apparatus may be tuned to exceed 80 pallets per hour with minimum defects. The pallet bag apparatus and process is designed to significantly reduce the manual labor involved in the current bagging process which could lead to increased safety and throughput, with a corresponding decrease in defects and costs.

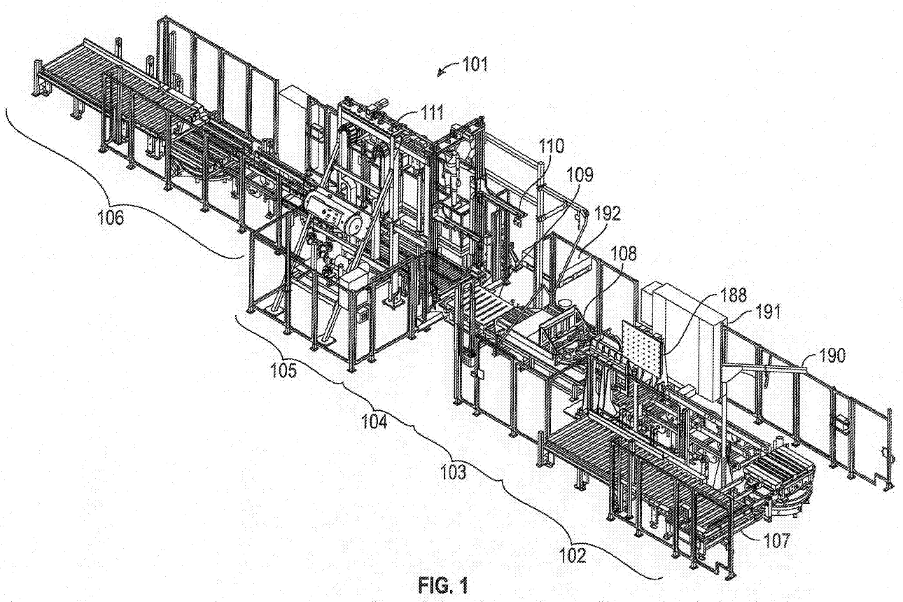

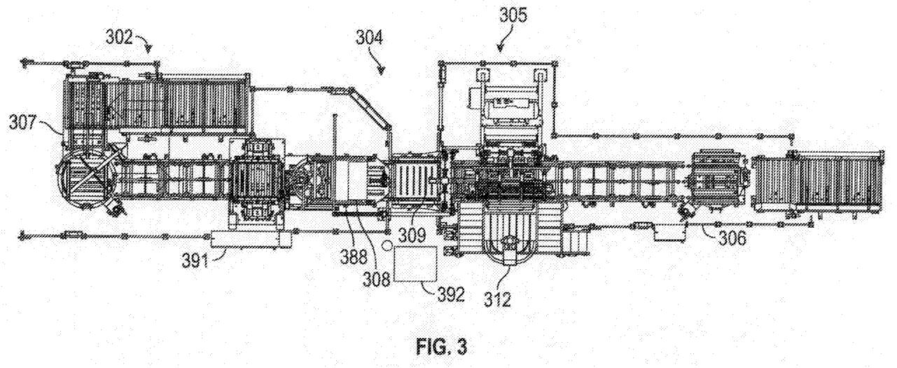

As depicted by example FIGS. 1-3, the apparatus has a plurality of stations. As depicted, the apparatus has five stations. FIG. 1 shows the front side of the apparatus 101 with five stations: station A (102); station B (103); station C (104); station D (105); and station E (106).

In one example, at station A two pallets are loaded side-by-side onto the machine at the “U” shaped conveyor end. The first pallet moves around the “U” shaped end (107) of the conveyor followed by a second pallet thereby opening space for additional pallets to be loaded onto the conveyor. At station B the pallet moves into position, the boxes of product (e.g., biological product such as fresh produce, fruits, vegetables) are squeezed by member (188). The wooden pallet, if any, drops away into a gap space and the product is lowered on to spatula members (108) that preferably rotate about 180 degrees to about 360 degrees, as the product moves to station C (104).

At station C (104) (a) a corrugated deck sheet (192) may be placed onto a wooden pallet (109) (to prevent nails or wood from piercing the bag) followed by an inverted pallet bag onto the wooden pallet; or (b) a 1-part bag with the reinforcement designed to eliminate the need for a deck sheet to minimize damage to the bag. The load of product from station B is moved from the spatula onto the pallet with bag in station C and the bag is then raised using mechanical arms (110) designed to move at least vertically. The arms may have suction cups or similar features to secure the bag.

At station D (105) the pallet moves into position at the seal bar (111) where appropriate gases are injected (e.g., CO₂), a vacuum is applied, and the bag is sealed by the seal bar. The bag may be sealed mechanically, by heat or a combination thereof. The pallet is lowered and moved to station E (106) where the pallet is moved into the discharge portion of the conveyor to be removed by a forklift, for example. A plurality of pallets may be removed, such a two pallets.

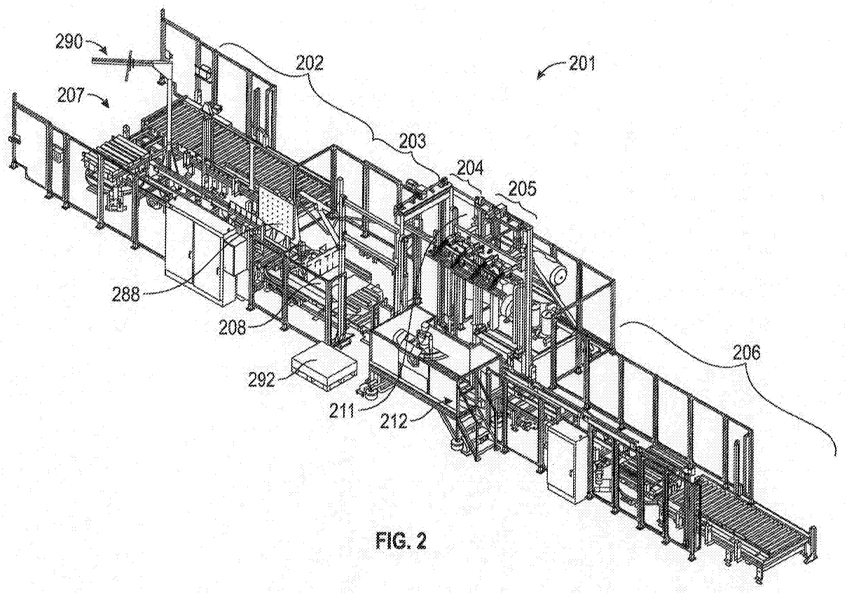

FIG. 2 depicts a rear view of apparatus 201 which shows aspects similarly numbered in the 200 number range but corresponding to the similarly numbered aspects in the 100 number range. In addition to the aspects previously described, FIGS. 1 and 2 also depict a pallet height sensor (190, 290) to determine which bag to use, such as per berry type or product container. Additionally, FIG. 2 depicts an optional moving mezzanine (212) that can raise and lower a worker if manual assistance is preferred under the circumstances with the seal bar/gas injection/vacuum (211).

FIG. 4 depicts the packaged pallets as loaded on a trick where the seal (402) is depicted in approximately the center portion of the pallet and runs along the top portion from one side to another. A membrane (403) is shown attached to the top portion and a reinforced portion (408) is show at the bottom portion of the pallets.

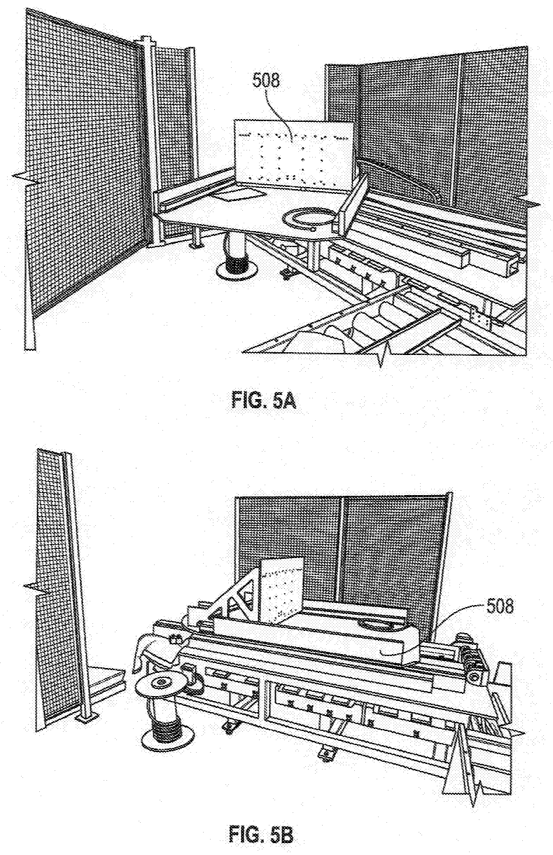

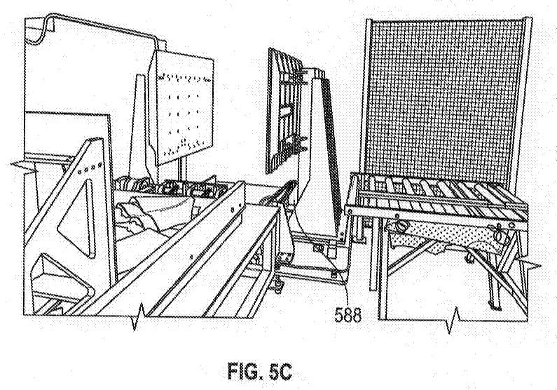

FIGS. 5a and 5b show the spatula device (508) used to transfer the material containers from station B to the receiving pallet in station C. As shown, the spatula device rotates about 180 degrees to turn the material containers from receiving the containers in station B to delivering the containers to the receiving pallet (609) in station C. The spatula device (508) is preferably movable to receive the material containers, turn and move the containers by extending the containers and spatula over the receiving pallet. FIG. 5c shows the squeeze members and apparatus that hold the material containers to allow the containers to be received by the spatula device.

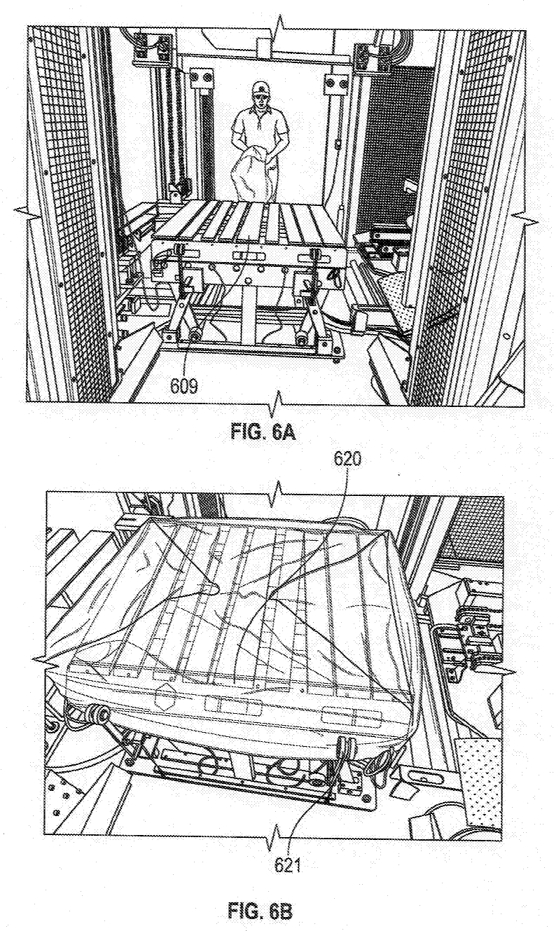

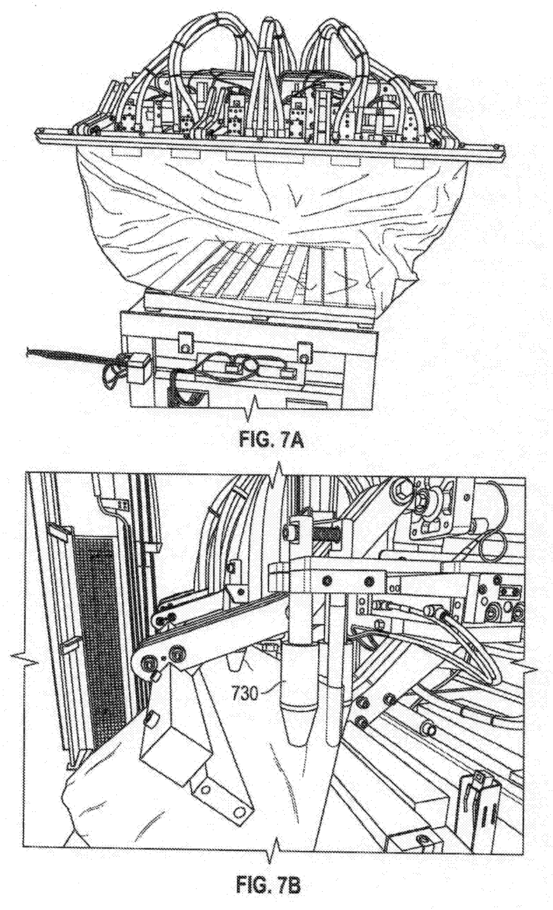

FIG. 6a shows the receiving pallet (609) onto which the material containers are placed by the spatula device (508). FIG. 6b shows the receiving pallet with a gathered pallet bag (620) over the receiving pallet such that it is positioned to raise over the material containers for processing in station D. Preferably, a single, bottom-up pallet bag system is used where the pallet bag is not taped or otherwise joined with a second portion of the pallet bag to form the enclosed pallet bag. Instead, a single pallet bag is used to form the enclosed pallet bag which is then sealed in station D. This materially reduces leaks and manpower hours while increasing the integrity of the pallet bag environment and efficiency of palletizing the material containers.

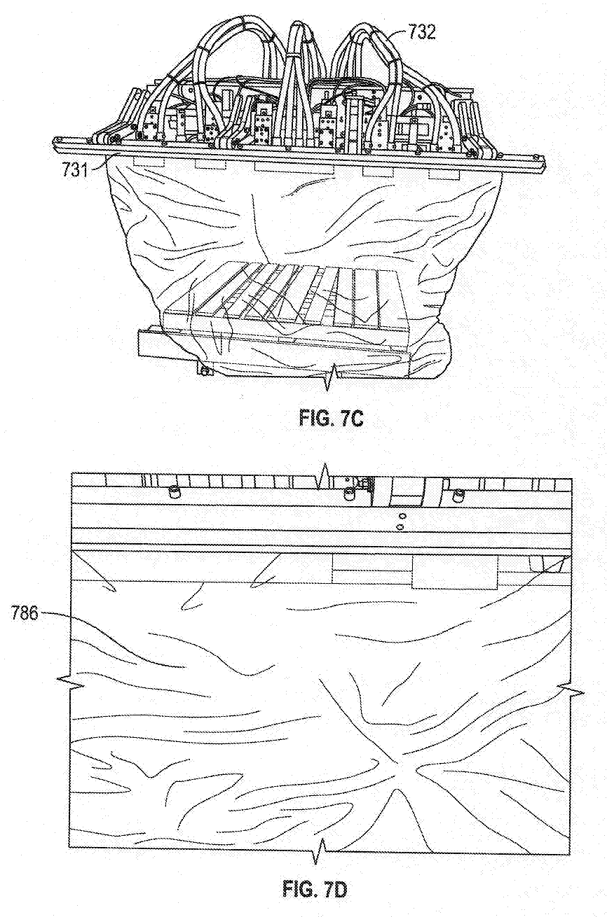

FIGS. 7a-7d depict different perspectives of the seal bar (731) which includes a plurality of gas injection nozzles (730), each of which may inject the same gas (e.g., CO₂) at a plurality of points, may inject a plurality of gasses (e.g., O₂, CO₂, ethylene) to create the desired environment or a combination thereof, may draw a vacuum (732) to remove excess gasses, and seal the pallet bag thereafter mechanically using pressure, using heat, or a combination thereof.

### EXAMPLES

### Example 1

Strawberry 9.7 lb Case Package—Example 379-126

Caseliner bags of size 26 inch×20 inch were prepared from LDPE with hole sizes under membranes as in the following table, hole covered by a “Jenny” membrane and insertion of one 26 gauge needle hole. Into the bags were placed 9.7 lb. fresh picked strawberries, pre-cooled and the cases held at 34° F. for 5 days.

| | Target injection | Hole diameter under |
|---|---|---|
| Sample number | CO₂ flush level | membrane (inches) |
| 379-126-A | 40% | 2.25 |
| 379-126-B | 30% | 1.75 |
| 379-126-C | 20% | 1.5 |
| 379-126-D | No flush | 0.5 |

The atmospheres were as follows:

| | | Days | | | | | |
|---|---|---|---|---|---|---|---|
| Design | Data | 0 | 8 hrs | 18 hrs | 1 | 2 | 4 |
| A-63-0091 | Average of % Oxygen | 11.97 | 12.53 | 11.32 | 10.05 | 9.17 | 7.72 |
| Jenny 2.25″ | Average of % Carbon Dioxide | 42.03 | 28.95 | 22.55 | 20.83 | 17.52 | 13.35 |
| LDPE flushed | Average of P. Ratio | 0.21 | 0.29 | 0.43 | 0.52 | 0.67 | 0.99 |
| ^{~}40% CO2 | Average of C2H4 ppm VOC | | | | 2.83 | 3.60 | 3.35 |
| B-23624 | Average of % Oxygen | 13.97 | 13.97 | 10.93 | 9.55 | 6.62 | 2.24 |
| Jenny 1.75″ | Average of % Carbon Dioxide | 32.62 | 20.52 | 20.02 | 19.12 | 18.96 | 18.14 |
| LDPE flushed | Average of P. Ratio | 0.21 | 0.34 | 0.50 | 0.59 | 0.75 | 1.03 |
| ^{~}30% CO2 | Average of C2H4 ppm VOC | | | | 3.48 | 3.94 | 5.10 |
| C-63-0089 | Average of % Oxygen | 15.55 | | 11.78 | 10.43 | 8.62 | 4.83 |
| Jenny 1.5″ | Average of % Carbon Dioxide | 24.52 | | 17.93 | 17.27 | 16.25 | 15.68 |
| LDPE flushed | Average of P. Ratio | 0.22 | | 0.51 | 0.61 | 0.76 | 1.03 |
| ^{~}20% CO2 | Average of C2H4 ppm VOC | | | | 3.98 | 4.18 | 5.67 |
| D-63-0089 | Average of % Oxygen | 20.90 | | 15.28 | 13.38 | 9.38 | 3.42 |
| Jenny 0.5″ | Average of % Carbon Dioxide | 0.01 | | 3.55 | 4.78 | 6.86 | 10.68 |
| LDPE not | Average of P. Ratio | 0.00 | | 1.57 | 1.55 | 1.68 | 1.64 |
| flushed | Average of C2H4 ppm VOC | | | | 3.77 | 4.58 | 5.34 |

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein the principles of the invention and the practical application, and to enable others of ordinary skill in the art to understand the invention for various embodiments with various modifications as are suited to the particular use contemplated.

What is claimed is:

1. A sealed pallet packaging system which comprises
(a) at least 100 lbs of biological material in a plurality of containers;
(b) a pallet bag comprising at least one atmosphere control member (ACM) and a reinforced portion; and
(c) a packaging atmosphere around the biological material,
wherein said pallet bag encloses the biological material and the packaging atmosphere which provides a pathway for oxygen and carbon dioxide to enter or leave the packaging atmosphere.

2. A sealed pallet packaging system according to claim 1 wherein the pallet bag encloses the biological material and the packaging atmosphere in a sealed environment.

3. A sealed pallet packaging system according to claim 2 wherein the biological material is a fruit which ripens through a climacteric.

4. A sealed pallet packaging system according to claim 3 wherein the biological material has not passed its climacteric.

5. A sealed pallet packaging system according to claim 1 wherein at least one ACM is attached to the top portion of the pallet bag.

6. A sealed pallet packaging system according to claim 3 wherein the biological material is selected from the group consisting of apples, apricots, avocados, bananas, blueberries, cherimoyas, dates, figs, kiwis, mangos, melons, peaches, papayas, pears, peppers, persimmons, plums, cherries, grapes, lemons, oranges, tomatoes, raspberries, blackberries, and strawberries.

7. A sealed pallet packaging system according to claim 1, wherein the biological material is selected from the group consisting of potatoes, onions, carrots, peppers, broccoli, celery, cucumbers, lettuce, corn, garlic, sweet potatoes, cauliflower, spinach, green beans, cabbage, kale, green onions, and asparagus.

8. A sealed pallet packaging system according to claim 1 wherein
(a) the biological material is bananas which have passed their climacteric,
(b) the packaging atmosphere contains 1.5 to 6% of oxygen and less than 15% of carbon dioxide, with the total quantity of oxygen and carbon dioxide being less than 16%, and
(c) the ACM has an R ratio at 13° C. of at least 2.

9. A sealed pallet packaging system according to claim 8 wherein the pallet bag has been sealed using heat treatment.

10. A sealed pallet packaging system according to claim 1 wherein the packaging atmosphere contains exogenous ethylene.

11. A method of preserving biological materials, the method comprising providing the sealed pallet packaging system of claim 1, wherein the biological material is placed in a plurality of containers, moved to a conveyor apparatus that stacks a plurality of containers on a pallet bag, which is mechanically extended to surround the containers and subsequently injected with a gas atmosphere including CO₂ and sealed.

12. A method according to claim 11 wherein the biological material is selected from the group consisting of apples, apricots, avocados, bananas, blueberries, cherimoyas, dates, figs, kiwis, mangos, melons, peaches, papayas, pears, peppers, persimmons, plums, cherries, grapes, lemons, oranges, tomatoes, raspberries, blackberries, and strawberries.

13. A method according to claim 11 wherein the biological material is selected from the group consisting of potatoes, onions, carrots, peppers, broccoli, celery, cucumbers, lettuce, corn, garlic, sweet potatoes, cauliflower, spinach, green beans, cabbage, kale, green onions, and asparagus.

14. A method according to claim 12 wherein the pallet bag is sealed using a seal bar applying heat.

15. A method according to claim 14 wherein at least one ACM is applied to the pallet bag in a location to avoid being blocked by an external barrier.

16. A system for automatically sealing a plastic bag/enclosure over containers of biological materials carried on a pallet, comprising: a sealing system for automatically sealing a pallet bag enclosing a plurality of containers of biological materials wherein said pallet bag encloses at least 100 lbs. of biological material; injecting at least one gas into said pallet bag to create an atmosphere surrounding said containers, and sealing the pallet bag containing said containers and atmosphere, wherein an ACM is attached to the pallet bag over a hole in the pallet bag in a location to avoid being blocked by an external barrier.

17. The system of claim 16, wherein the pallet bag is a single bag that is raised over the containers of biological materials from the bottom up.

18. The system of claim 15 wherein at least one ACM is applied to the top portion of the pallet bag.
